(19) United States
(12) Patent Application Publication
(10) Pub. No.: US 2025/0058496 A1
(43) Pub. Date: Feb. 20, 2025

(54) ASSEMBLY FOR GUIDING A HELICAL BODY INTO A VISCOUS, PLIABLE, OR SOLIDIFYING MATERIAL

(71) Applicant: TECHNISCHE UNIVERSITEIT EINDHOVEN, Eindhoven (NL)

(72) Inventors: Freek Paul BOS, Eindhoven (NL); Lauri HASS, Eindhoven (NL)

(21) Appl. No.: 18/723,747

(22) PCT Filed: Dec. 27, 2022
(86) PCT No.: PCT/NL2022/050762

§ 371 Date: Jun. 24, 2024

(30) Foreign Application Priority Data
Dec. 24, 2021 (NL) 2030291

(51) Int. Cl. B28B 17/00; B28B 23/02; E04G 21/22

(52) U.S. Cl. CPC B28B 17/0081; B28B 23/02; E04G 21/22

(57) ABSTRACT

An assembly for guiding into a viscous, pliable, or solidifying material, a body having a helical geometry having an axis and a pitch distance, and the body having an insertion end configured to enter the material at an insertion point of the material. The assembly includes at least one guide and gripper for guiding the body along the axis of the helical geometry, and at least one motor for translating the body toward the material and rotate the body around the axis of the helical geometry, wherein the motor is configured to synchronize the translation and rotation of the body such that, for each fraction of a 360-degree rotation that the body is rotated, the body is translated the same fraction of the pitch distance.

### TECHNICAL FIELD

The present disclosure relates generally to inserting helical bodies into viscous, pliable, or solidifying materials. Particular embodiments relate to an assembly for guiding into a viscous, pliable or solidifying material a body having a helical geometry, and to a method for guiding into a viscous, pliable or solidifying material a body having a helical geometry.

### BACKGROUND

Extrusion-based 3D printed (cementitious) mortars (usually referred to as 3D concrete printing, or: 3DCP) generally have insufficient tensile strength and ductility to be used safely in structural applications in the construction industry. In conventional cast concrete this is solved by preplacing reinforcement bars and casting concrete around these bars. In 3D printed concrete and cementitious mortars, this is not possible due to the nature of the process. Instead, reinforcement elements may be placed (manually or robotically) into the printed material after deposition. Just placing or pressing elements into the concrete, however, has significant drawbacks. Due to the low-slump characteristics of printable concrete, cavities are easily created around elements, resulting in (very) low bond strength between concrete and reinforcement element (as the bond between reinforcement and concrete is predominantly achieved by mechanical (geometrical) interlock. By screwing, instead of pushing, this problem is overcome. Due to the screwing motion, elements can be introduced into the mortar firmly without resulting in cavities and with creating high dilation resistance. The method can be applied through significant thicknesses of printed concrete in many different directions, also across horizontal and vertical interfaces. It may also be applied through multiple materials, thus effectively bonding different materials together. Thus, this is a very versatile method with many application possibilities in the realm of printed concrete.

The concept of such screw reinforcement was introduced by the inventors in Hass & Bos [1] and was simultaneously also presented in Freund et al. [2].
[1] L. Hass, F. Bos, Bending and pull-out tests on a novel screw type reinforcement for extrusion-based 3D printed concrete, in: RILEM Bookseries, Springer, 2020, pp. 632-645, https://doi.org/10.1007/978-3-030-49916-7_64.
[2] N. Freund, I. Dressler, D. Lowke, Studying the bond properties of vertical integrated short reinforcement in the shotcrete 3D printing process, Springer, Cham, 2020, pp. 612-621, https://doi.org/10.1007/978-3-030-49916-7_62.

### SUMMARY

However, both publications use manually inserted screws. This is cumbersome and therefore limits the speed at which the above-described approaches can operate. Moreover, having to manually insert screws limits the accuracy and versatility. Furthermore, having to manually inserts screws in the environment of 3DCP may lead to safety concerns for operators in the vicinity of robotic 3DCP installations.

Embodiments according to the present disclosure therefore aim to alleviate the above-described disadvantages.

According to a first aspect of the present disclosure, there is provided an assembly for guiding into a viscous, pliable, or solidifying material, i.e. having a viscosity ≥10,000 mPa·s, having an E-modulus ≤1,000 MPa, or undergoing a phase transition from fluid to solid, a body having a helical geometry, the helical geometry being characterized by an axis and a pitch distance (i.e. the distance from any point on the thread of a screw to the corresponding point on an adjacent thread measured parallel to the axis), the body having an insertion end configured to enter into the viscous, pliable, or solidifying material at an insertion point of the viscous, pliable, or solidifying material, the assembly comprising:
at least one guiding and gripping means configured to guide the body along the axis of the helical geometry and configured to grip the body;
at least one motor configured to translate (i.e. impart a translation on) the body towards the viscous, pliable, or solidifying material and configured to rotate (i.e. impart a rotation on) the body around the axis of the helical geometry;
   wherein the at least one motor is configured to synchronize the translation and the rotation of the body such that, for each fraction of a 360 degree rotation that the body is rotated, the body is translated the same fraction of the pitch distance.

By synchronizing the translation and the rotation of the body, it is possible to guide the body into the material even when the material is viscous, pliable or solidifying and the material would thus not allow a helical body such as a screw to be screwed in conventionally.

In other words, there is provided an assembly, i.e. a mechanical device, that allows robotically controlled insertion of screw reinforcement and other bars with a helical geometry or helical surface. This allows for a previously impossible industrial scale application of the concept, as it leads to increased accuracy of placement, increased placement speed, increased safety (as people can stay out of the range of printing robots, and increased versatility (as the device can more easily place screws of different sizes and types in almost any angle). Therefore, this solution alleviates at least some of the above-described disadvantages.

The versatility of the assembly may actually also allow application in other domains than that of concrete printing, including (prefab) cast concrete, and (prefab) timber construction.

Note that the viscous, pliable, or solidifying material may also comprise a combination of multiple different viscous, pliable, or solidifying materials.

Note that the body may also be endless in the sense that it only has an insertion end and that its other end is being continually produced, for example from an extrusion machine.

In an embodiment, the at least one guiding and gripping means comprises at least three rollers arranged parallel to each other and parallel to the axis of the helical geometry. In a first preferred embodiment, the rollers are arranged such that there are always two rollers opposite to each other in view of any plane through and parallel with the axis of the helical geometry. In a second preferred embodiment, the rollers are arranged at 120 degrees from each other around the axis of the helical geometry.

In an embodiment, the at least one guiding and gripping means comprises:
a guiding means configured to guide the body along the axis of the helical geometry and arranged at a first position along the axis of the helical geometry; and
a gripping means configured to grip the body, the gripping means being arranged at a second position along the axis of the helical geometry, different from the first position.

By arranging the guiding means and the gripping means at the first position and the second position respectively, the body can be guided with sufficient geometrical stability.

In a specific embodiment, the at least one guiding and gripping means is constituted by the guiding means and the gripping means.

In an embodiment, the body has a helical geometry by comprising a helical thread at a surface of the body; or wherein the body is a helix.

In this context, a helix may be defined as a winding spring-shaped body.

In an embodiment, the body is characterized in that a longitudinal axis of the body coincides with the axis of the helical geometry.

In an embodiment, the body is a screw or a bolt.

In an embodiment, the guiding means is configured to extend along the body over at least the pitch distance.

In an embodiment, in operation, the first position is within 100 cm, preferably within 30 cm, most preferably within 10 cm of the insertion point of the viscous, pliable, or solidifying material, measured along a measurement axis extending outward from the viscous, pliable, or solidifying material.

In an embodiment, the guiding means comprises a gripper configured to grip the body.

In an embodiment featuring the at least three rollers, the at least one motor is configured to drive the at least three rollers to cause translation and rotation of the body.

In an embodiment featuring the guiding means and the gripping means at different positions along the axis of the helical geometry, the at least one motor comprises a first motor configured to translate the body and a second motor configured to rotate the body.

In an embodiment, the assembly comprises a driver arranged, in operation, at an end of the body opposite to the insertion end, wherein the at least one motor is configured to use the driver for at least the rotating of the body, and preferably both for the translating and the rotating of the body.

In a further developed embodiment, the body is a screw and the driver comprises a screw bit configured to enter a recess in a head of the screw, wherein the screw bit is preferably configured to enter the recess in the head of the screw at most partially, in order to limit a translational pressure exerted by the screw bit onto the screw towards the viscous, pliable, or solidifying material; or the body is a bolt and the driver comprises a bolt bit configured to receive a head of the bolt.

In a further developed embodiment, the gripping means is configured to release the body, based on a distance, in operation, between the gripping means and the insertion point of the viscous, pliable, or solidifying material being lower than a first threshold, in order to make room for the driver.

In an embodiment featuring the guiding means and the gripping means at different positions along the axis of the helical geometry, the guiding means is configured to release the body, based on a distance, in operation, between the gripping means and the guiding means being lower than a second threshold, in order to make room for the gripping means.

This allows to prevent the gripping means and the guiding means from colliding with each other.

In an embodiment featuring the guiding means and the gripping means at different positions along the axis of the helical geometry, the second position is, in operation, farther away from the insertion end of the body than the first position.

In an embodiment, the gripping means is comprised in a sliding unit configured to slide along a guide rail extending along a sliding axis essentially parallel to the axis of the helical geometry.

In an embodiment, the at least one motor is further configured to measure a torque applied on the body by the at least one motor.

In an embodiment, the viscous, pliable, or solidifying material comprises any one of the following or any combination thereof: a printable mortar prior to hardening; a printable concrete prior to hardening; a pliable foam; a pliable clay-based product prior to hardening; and optionally the viscous, pliable, or solidifying material additionally comprises at least one timber element.

In an embodiment, the assembly is moreover configured to guide the body out of the viscous, pliable, or solidifying material, and/or out of the material after the material has solidified, and the at least one motor is further configured to translate the body out of the material.

According to a first aspect of the present disclosure, there is provided a method for guiding into a viscous, pliable, or solidifying material, a body having a helical geometry, the helical geometry being characterized by an axis and a pitch distance, the body having an insertion end configured to enter into the viscous, pliable, or solidifying material at an insertion point of the viscous, pliable, or solidifying material, the method using an assembly according to any previous claim and comprising:
guiding the body along the axis of the helical geometry;
gripping the body;
translating the body towards and optionally out of the viscous, pliable, or solidifying material; and
rotating the body around the axis of the helical geometry;
   wherein the translation and rotation of the body are synchronized such that, for each fraction of a 360 degree rotation that the body is rotated, the body is translated the same fraction of the pitch distance.

The skilled person will understand that features and advantages of the assembly may apply to the method as well, mutatis mutandis.

In an embodiment, at least the steps of guiding the body and gripping the body are performed by at least three rollers arranged parallel to each other and parallel to the axis of the helical geometry.

In an embodiment, the step of guiding the body is performed at a first position along the axis of the helical geometry, and wherein the step of gripping the body is performed at a second position along the axis of the helical geometry, different from the first position.

In an embodiment, the step of translating the body towards the viscous, pliable, or solidifying material comprises inserting the body either partially, or flush, or fully into the material, such that either a portion of the body remains extending outside of and away from the material, or the body is lodged in the material flush with the surface of the material, or a recess is created between the insertion point and the body, respectively.

In case a portion of the body remains extending outside of and away from the material, this portion may advantageously be used as an anchor, a male connection point, a lifting hinge, etc.

In case a recess is created between the insertion point and the body, in other words when a recess is created in the surface of the material, wherein the bottom of the recess is formed by the end of the body opposite from its insertion end, the body may advantageously be hidden entirely within the material, e.g. for safety and/or aesthetic purposes, and preferably the resulting recess may be filled to smoothen the surface of the material.

### DESCRIPTION

Although several reinforcement concepts for 3DCP are being researched by different research groups and commercially operating companies, no generally accepted industrial scale solution has yet been found. This is an important reason why 3D printed cementitious mortars are only used to a very limited extent in the built environment, and when they are, load-bearing applications are generally avoided or the mortar is applied in a fashion similar to unreinforced masonry, which severely limits the application possibilities.

Solution strategies to provide ductility to printed concrete are based on:
Application of fibres, but this does not work across the interfaces of printed filament, and thus holds significant limitations in comparison to the invented method.
Application of discrete elements into the concrete.
   Methods based on pushing elements into concrete, with the disadvantages described above.
   Methods based on entraining cables or mesh into print concrete filament; these methods only work in the filament direction, whereas the invented method works in all other directions, and across interfaces.
   The concept of screwing, presented by [1] and [2] has not yet been applied in practice. The lack of an automated fashion to apply this forms a serious obstacle in the adoption of this concept.

In the following description, a particular exemplary embodiment according to the present disclosure will be described in more detail. This description is intended to help understanding and should not be taken to limit the scope of the invention, which is defined by the independent claim. Moreover, any one feature or any combination of features present in the following particular exemplary embodiment that is not present in the independent claim may be considered optional, insofar as the skilled person sees fit in practice.

The assembly is a robotic end-effector capable of introducing screws or other bar-like elements with a helical geometry or helical surface (hereafter: screw) into viscous, materials, such as fresh printable mortars, without creating large disturbances in the surrounding matrix during placement, or other pliable or soft solids, such as printable and castable mortars and concretes before their initial setting time, various types of foam, timber, and so on. These screws can act as local or continuous reinforcement, and/or as anchors.

The assembly is attached to a (commercially available) industrial arm type robot. The industrial robot moves the assembly to the desired global position. The assembly subsequently takes care of the local placement of the screw, in a fashion explained below.

Using two grippers, the assembly can pick up a prepositioned screw. After the arm robot brings it into the appropriate global position, the assembly inserts the screw into a designated substrate (e.g. fresh concrete) by a synchronized linear translation in combination with a rotation.

These two movements are induced by two separately controlled motors. The movements are synchronized so that the duration of one revolution corresponds to the linear translation of 1 time the screw pitch. The grippers also serve to keep the screw straight during the process. The top gripper moves with the linear translation, while the bottom gripper remains stationary. The grippers can be released independently so that the bottom gripper can be released when the top gripper comes close. The top gripper then continues until it almost reaches the surface of the substrate into which the screw is inserted. It then releases too, but the linear translation can still continue until the screw head levels with the surface. The software control system allows the programming of each of the motors (for rotation and linear translation) and grippers to adjust to the specific need. The rotating motor is fitted with an interchangeable screw bit to account for various types of screw head.

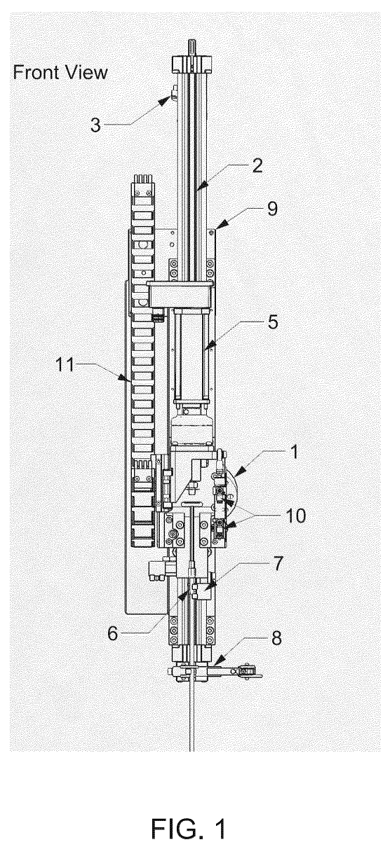

FIG. 1 shows a front view of the assembly.

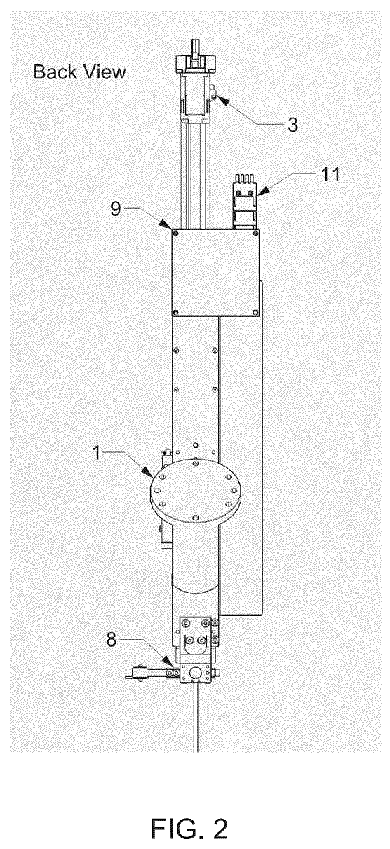

FIG. 2 shows a back view of the assembly.

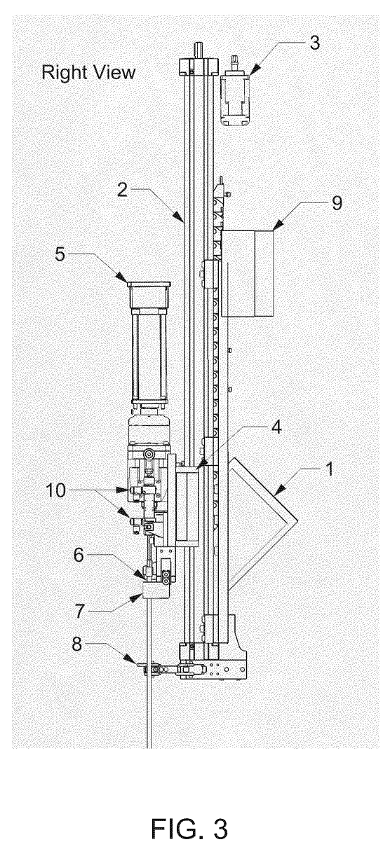

FIG. 3 shows a right view of the assembly.

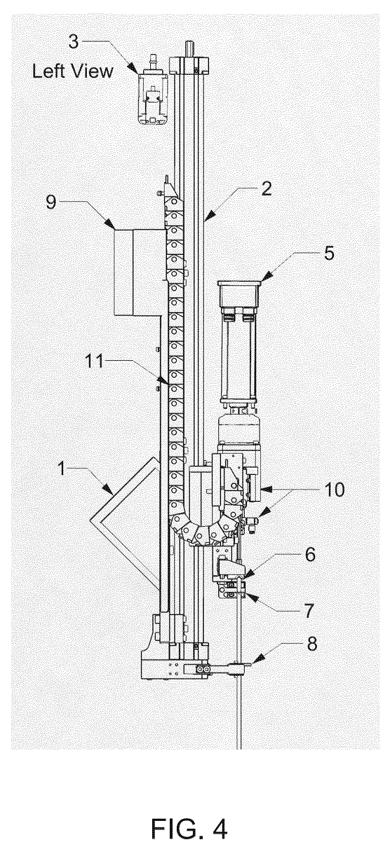

FIG. 4 shows a left view of the assembly.

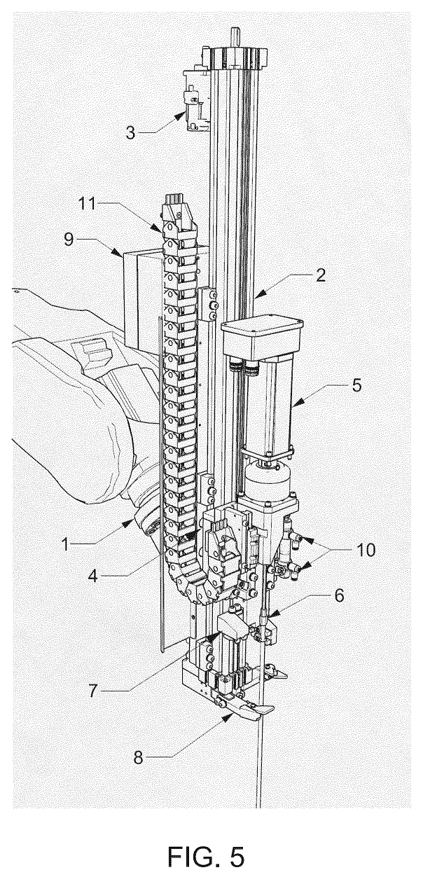

FIG. 5 shows a perspective view of the assembly.

### PARTS

(1) Mounting bracket
(2) Guide rail
(3) Motor unit 1
(4) Sliding unit
(5) Motor unit 2
(6) Screw bit
(7) Top gripper
(8) Bottom gripper
(9) Electronics box
(10) Air inlet for the pneumatic actuators
(11) Moving cable protection
(12) Pneumatic actuator

### Design

The assembly is mounted to a robot (e.g. industrial arm robot, not part of the invention) capable of moving the device in its entirety, with a mounting bracket (1). The main part of assembly consists of a sliding unit (4) which can be moved along a guide rail (2) through operation of motor unit 1 (3). The sliding unit contains the motor unit 2 (5) and top gripper (7). The motor unit 2 also has torque measurement capabilities, to record the applied torque during placement. The motor unit 2 (5) in turn is equipped with a screw bit (6) and is capable of a limited secondary linear movement by a pneumatic actuator (12), along the same axis as the main guide rail axis. This allows the screw bit to enter into the recess in a screw head. Attached to the guide rail (2), furthermore, is the bottom gripper (8). The bottom gripper (8) is designed in such a way that the sliding unit (4) can move past it when the bottom gripper (8) is released. The operation of the mechanical components (i.e. motor unit 1 (3), motor unit 2 (5), top gripper (7) and bottom gripper (8)) is integrated in the robot controller of the robot to which the assembly is mounted, through a custom developed script, which allows to control the settings of the necessary parameters (e.g. pitch, RPM, screw length, gripper locations).

To account for potential dimensional deviations in the screws, the following solutions were applied: 1) The screw bit sits half way inside the screw head, in order for it to not press the screw, but still be enough inside the screw head that the rotational force is transferred over; 2) The bottom gripper does not prevent the screw to move in the direction the translational motion is applied (however it does prevent the movement out of that same axis), hence the bottom gripper is only guiding the reinforcement element; 3) The top gripper acts the same way at the bottom gripper, except the translational motion is limited.

### Operation

### Picking Up a Screw

Bring the sliding unit in the desired start position, i.e. translated up along the guide rail far enough for the grippers to grip the screw.
Release the grippers
By using the robot, move the assembly to the desired position where the screw needs to be picked up.
Close the grippers around the screw. Lower the screw bit into the screw head by the pneumatic actuator.

### Inserting a Screw

By using the robot, move the assembly to the desired position where the screw needs to be inserted.
Both motors are activated simultaneously to move the sliding unit with the screw downwards with the calculated translational speed (based on the pitch and given RPM), while also applying the given RPM itself.
When the sliding unit is moved downward sufficiently (when the sliding unit would collide with the bottom gripper), release the bottom gripper and continue moving the sliding unit down.
When the sliding unit is moved downward sufficiently, release the top gripper.
(if the screw needs to be inserted further), continue moving the sliding unit further down until the screw reaches its final position.
When the screw reaches its final position the pneumatic actuator pulls the screw bit out of the screw head and subsequently both motors stop and move to loading positions.

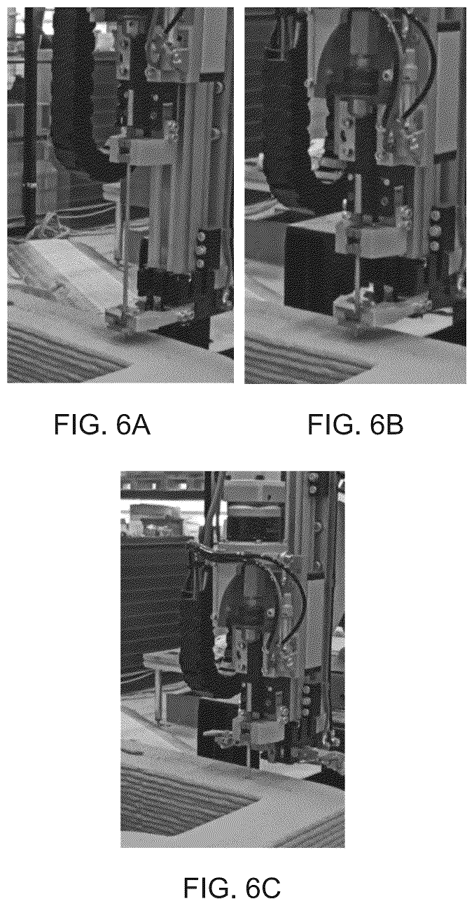

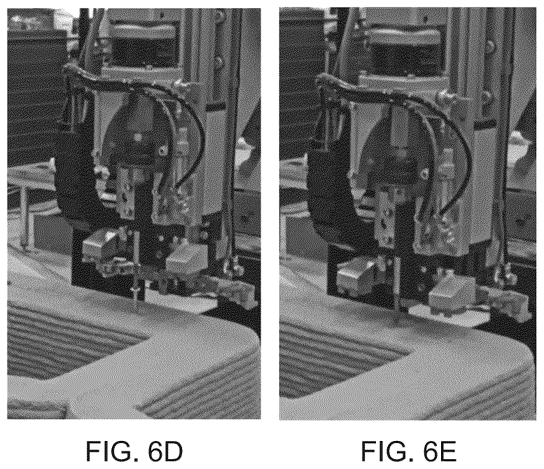

FIGS. 6A-6E shows the insertion of a screw into printed concrete.

In another embodiment, which is not illustrated, the at least one guiding and gripping means comprises at least three rollers arranged parallel to each other and parallel to the axis of the helical geometry. These rollers may preferably be arranged suitably on all sides of the body, for example at 120 degrees relative to each other in view of the axis of the helical geometry, in order to ensure that the body is effectively gripped and guided. The at least three rollers may be configured to grip the body by pinching against it, and by virtue of the friction exerted by the helical geometry, the body may be gripped in place. The at least three rollers may be configured to guide the body by extending alongside it, thus forcing the body to respect the alignment of the at least three rollers. At least one of, preferably all of, the at least three rollers may be coupled with one motor of the at least one motor, such that the at least one motor may rotate the one of, or all of, the at least three rollers. In case not all rollers of the at least one roller are being driven by the at least one motor, the non-driven rollers may of course still guide and grip the body because of the reaction force. By virtue of the helical geometry of the body and the resulting friction exerted between the body and that or those rollers, the rotation imparted onto that or those rollers by the at least one motor will be imparted onto the body and will result both in a rotation of the body (due to the rotation of the rollers) as well as in a translation of the body (due to the helical geometry of the body upon which a rotation is being imparted).

This other embodiment is generally useful, and in particular for bodies with a relatively low geometrical stiffness, which may require such parallel rollers, preferably relatively long rollers.

1-25. (canceled)

26. An assembly for guiding into a viscous, pliable, or solidifying material, a body having a helical geometry, the helical geometry having an axis and a pitch distance, and the body having an insertion end configured to enter into the viscous, pliable, or solidifying material at an insertion point of the viscous, pliable, or solidifying material, the assembly comprising:
at least one guide and gripper subassembly configured to guide the body along the axis of the helical geometry and grip the body; and
at least one motor configured to translate the body towards the viscous, pliable, or solidifying material, and configured to rotate the body around the axis of the helical geometry;
wherein the at least one motor is configured to synchronize translation and rotation of the body such that, for each fraction of a 360-degree rotation that the body is rotated, the body is translated the same fraction of the pitch distance.

27. The assembly according to claim 26, wherein the at least one guide and gripper subassembly comprises at least three rollers arranged parallel to each other and parallel to the axis of the helical geometry.

28. The assembly according to claim 27, wherein the at least one motor is configured to drive the at least three rollers to cause translation and rotation of the body.

29. The assembly according to claim 26, wherein the at least one guide and gripper subassembly comprises:
a guide configured to guide the body along the axis of the helical geometry positioned at a first position along the axis of the helical geometry; and
a gripper configured to grip the body positioned at a second position along the axis of the helical geometry, different from the first position.

30. The assembly according to claim 29, wherein, in use, the first position is within 100 cm of the insertion point of the viscous, pliable, or solidifying material, measured along a measurement axis extending outward from the viscous, pliable, or solidifying material.

31. The assembly according to claim 26, wherein the helical geometry is provided by a helical thread positioned at a surface of the body, or wherein the helical body is a helix.

32. The assembly according to claim 26, wherein a longitudinal axis of the body coincides with the axis of the helical geometry.

33. The assembly according to claim 26, wherein the body is a screw or a bolt.

34. The assembly according to claim 26, wherein the at least one guide and gripper subassembly extends along the body over at least the pitch distance.

35. The assembly according to claim 26, wherein the at least one motor comprises a first motor configured to translate the body and a second motor configured to rotate the body.

36. The assembly according to claim 29, further comprising a driver positioned at an end of the body opposite the insertion end, coupled to the at least one motor, configured to at least one of translate and rotate the body.

37. The assembly according to claim 36, wherein the body is a screw and the driver comprises a screw bit configured to enter a recess formed in a head of the screw, wherein the screw bit is configured to enter the recess in the head of the screw at most partially, in order to limit a translational pressure exerted by the screw bit onto the screw towards the viscous, pliable, or solidifying material, or the body is a bolt and the driver comprises a bolt bit configured to receive a head of the bolt.

38. The assembly according to claim 36, wherein the at least one guide and gripper subassembly is configured to release the body, based on a distance between the gripper and the insertion point of the viscous, pliable, or solidifying material being lower than a first threshold, to make room for the driver.

39. The assembly according to claim 38, wherein the at least one guide and gripper subassembly is configured to release the body, based on a distance between the gripper the guide being lower than a second threshold, to make room for the gripper.

40. The assembly according to claim 29, wherein the second position is farther away from the insertion end of the body than the first position.

41. The assembly according to claim 29, wherein the gripper is provided in a sliding unit configured to slide along a guide rail extending along a sliding axis parallel to the axis of the helical geometry.

42. The assembly according to claim 26, wherein the viscous, pliable, or solidifying material comprises at least one of a printable mortar before, a printable concrete before hardening, a pliable foam, a pliable clay-based product before hardening, and at least one timber element.

43. A method for guiding into a viscous, pliable, or solidifying material, a body having a helical geometry, the helical geometry having an axis and a pitch distance, and the body having an insertion end configured to enter into the viscous, pliable, or solidifying material at an insertion point of the viscous, pliable, or solidifying material, the method performed using an assembly according to claim 26, and the method comprising the steps of:
guiding the body along the axis of the helical geometry;
gripping the body;
translating the body towards and optionally out of the viscous, pliable, or solidifying material; and
rotating the body around the axis of the helical geometry;
wherein the translation and rotation of the body are synchronized such that, for each fraction of a 360-degree rotation that the body is rotated, the body is translated the same fraction of the pitch distance.

44. The method according to claim 45, wherein at least the steps of guiding the body and gripping the body are performed by at least three rollers arranged parallel to each other and parallel to the axis of the helical geometry.

45. The method according to claim 45, wherein the step of guiding the body is performed at a first position along the axis of the helical geometry, and wherein the step of gripping the body is performed at a second position along the axis of the helical geometry, different from the first position.
